(19) United States
(12) Patent Application Publication
(10) Pub. No.: US 2014/0150416 A1
(43) Pub. Date: Jun. 5, 2014

(54) HYDRAULIC ACTUATOR DAMPING CONTROL SYSTEM FOR CONSTRUCTION MACHINERY

(71) Applicant: Chun-Han Lee, Gimhae-si (KR)

(72) Inventor: Chun-Han Lee, Gimhae-si (KR)

(73) Assignee: VOLVO CONSTRUCTION EQUIPMENT AB, Eskilstuna (SE)

(21) Appl. No.: 14/131,792

(22) PCT Filed: Jul. 12, 2011
(86) PCT No.: PCT/KR2011/005087

§ 371 Date: Jan. 9, 2014

(51) Int. Cl. E02F 9/22; F15B 11/044; F15B 11/042

(52) U.S. Cl. CPC E02F 9/2207; F15B 11/042; F15B 11/044; E02F 9/2228
USPC 60/327; 92/143; 60/459

(57) ABSTRACT

Disclosed is an actuator damping control system for reducing shocks imparted to a hydraulic actuator caused by a change in load resulting from an abrupt manipulation of a boom or other working device. The hydraulic actuator damping control system for construction machinery according to one embodiment of the present invention comprises: first and second supply passages both supplying a hydraulic flow from a hydraulic pump to an inlet of an actuator; first and second discharge passages, both of which return the hydraulic flow from the actuator to a hydraulic tank; a first meter “in” control valve and a first meter “out” control valve for controlling the hydraulic flow supplied from the hydraulic pump to the actuator inlet and the hydraulic flow returned from the actuator outlet to the hydraulic tank, respectively, in order to control the actuator in a direction; a second meter “in” control valve and a second meter “out” control valve for controlling the hydraulic flow supplied from the hydraulic pump to the actuator inlet and the hydraulic flow returned from the actuator outlet to the hydraulic tank, respectively, in order to control the actuator in another direction; and a controller for outputting control signals for opening either the first or second meter “in” control valve according to the degree to which a joystick is manipulated and the load on the actuator, and for opening either the first or second meter “out” control valve when the load on the actuator exceeds a reference value.

### FIELD OF THE INVENTION

The present invention relates to a hydraulic actuator damping control system for a construction machine. More particularly, the present invention relates to a hydraulic actuator damping control system for a construction machine, in which a shock or a vibration occurring in a hydraulic actuator (referring to “boom cylinder”) due to a load change can be reduced during an abrupt manipulation or a combined operation of a work apparatus (or attachment) such as a boom or the like.

### BACKGROUND OF THE INVENTION

In general, construction machine such as an excavator consists of work apparatuses of a large-scaled structure like a boom and the like and is heavy weight. For this reason, when an abrupt manipulation or a combined operation of the work apparatus is performed by a joystick, a great vibration and shock occurs in the entire equipment, which results in an increase in the degree of fatigue of an operator during the work time.

Meanwhile, control valves configured to be driven independently, for example, four control valves are arranged in a bridge pattern so that when the operation of a hydraulic actuator such as a boom cylinder is controlled, two control valves can be controlled to cause the hydraulic cylinder to be driven in a direction. In other words, the construction machine employs a first control valve that controls the flow rate of a hydraulic fluid that is supplied from a hydraulic pump to an inlet of the hydraulic cylinder, and a second control valve that controls the flow rate of a hydraulic fluid that is returned from an outlet of the hydraulic cylinder to a hydraulic tank

In this case, a shock or a vibration occurs in the hydraulic cylinder due to a load change can be reduced when an abrupt manipulation or a combined operation of the work apparatus is performed by the manipulation of the joystick. Thus, a damping control valve that returns the hydraulic fluid discharged from the hydraulic pump to the hydraulic tank is installed in the construction machine so as to reduce the shock.

In this case, the damping control valve is separately used to reduce the shock, leading to an increase in the manufacturing cost. In addition, the entire hydraulic system is controlled by a single damping control valve, and thus a shock occurring in another hydraulic actuator (e.g., arm cylinder or the like) cannot be controlled independently.

### DETAILED DESCRIPTION OF THE INVENTION

### Technical Problems

Accordingly, the present invention has been made to solve the aforementioned problem occurring in the prior art, and it is an object of the present invention to provide a hydraulic actuator damping control system for a construction machine, which can eliminate the necessity for additional installation of a separate damping control valve to reduce a shock and a vibration occurring when an abrupt manipulation or a combined operation of a work apparatus is performed by a joystick, and can smoothly operate the work apparatus according to an intention of an operator.

### Technical Solution

To accomplish the above object, there is provided a hydraulic actuator damping control system for a construction machine in accordance with an embodiment of the present invention, the system including:

at least one hydraulic actuator connected to a variable displacement hydraulic pump;

first and second supply paths connected in parallel to a discharge flow path of the hydraulic pump and configured to allow a hydraulic fluid from the hydraulic pump to be respectively supplied to an inlet and an outlet of the actuator;

first and second discharge paths branch-connected to the first and second supply paths, respectively and configured to allow the hydraulic fluid from the actuator to be returned to a hydraulic tank;

a first meter-in control valve and a first meter-out control valve configured to be switched to control the flow rate of the hydraulic fluid that is supplied from the hydraulic pump to the inlet of the actuator and the flow rate of the hydraulic fluid that is returned from the outlet of the actuator to the hydraulic tank, respectively, so that the actuator can be driven in a direction;

a second meter-in control valve and a second meter-out control valve configured to be switched to control the flow rate of the hydraulic fluid that is supplied from the hydraulic pump to the outlet of the actuator and the flow rate of the hydraulic fluid that is returned from the inlet of the actuator to the hydraulic tank, respectively, so that the actuator can be driven in the other direction;

an electric joystick configured to output an electric control signal that corresponds to a manipulation amount; and

a controller configured to control any one of the first and second meter-in control valves to be opened by the control signal according to the manipulation amount of the electric joystick and a control signal according to a load generated in the actuator, and output a control signal to open any one of the first and second meter-out control valves that control the flow rate of the hydraulic fluids that are returned from the outlet and the inlet of the actuator to the hydraulic tank, respectively, if the load generated in the actuator exceeds a reference value.

There is also provided a method for controlling the damping of a hydraulic actuator in a hydraulic actuator damping control system for a construction machine in accordance with an embodiment of the present invention.

The hydraulic actuator damping control system for a construction machine includes a hydraulic actuator connected to a variable displacement hydraulic pump, a first meter-in control valve and a first meter-out control valve configured to be switched to control a hydraulic fluid that is supplied from a hydraulic pump to an inlet of the actuator and a hydraulic fluid that is returned from an outlet of the actuator to a hydraulic tank, respectively, so that the actuator can be driven in a direction, a second meter-in control valve and a second meter-out control valve configured to be switched to control the flow rate of the hydraulic fluid that is supplied from the hydraulic pump to the outlet of the actuator and the hydraulic fluid that is returned from the inlet of the actuator to the hydraulic tank, respectively, so that the actuator can be driven in the other direction, an electric joystick, and a controller.

The method for controlling the damping of a hydraulic actuator includes the steps of:

reading a control signal value through a manipulation of the joystick, a pressure value generated at the inlet of the actuator, and a set pressure value at the hydraulic pump;

determining a difference between the control signal value according to the manipulation of the joystick and a reference value for determining whether the joystick is manipulated;

calculating a difference between the set pressure at the hydraulic pump and a target pressure at the inlet of the actuator if the control signal value according to the manipulation of the joystick exceeds the reference value;

determining whether an actual load generated at the inlet of the actuator exceeds the target pressure; and

outputting a control signal to open any one of the first and second meter-out control valves that controls the flow rate of the hydraulic fluid that is returned from the inlet of the actuator to the hydraulic tank, respectively, if the actual load generated at the inlet of the actuator exceeds the target pressure,

whereby if the actual load generated at the inlet of the actuator according to the manipulation of the joystick exceeds the target pressure, a closed loop is formed and a control is repeatedly performed to reduce a shock due to a load change that occurs in the actuator by opening any one of the first and second meter-out control valves according to the control signal applied to any one of the first and second meter-out control valves.

In accordance with a preferred embodiment, the hydraulic actuator damping control system further includes a pressure sensor configured to detect the pressure generated in the actuator and transmit a detection signal to the controller.

If the actual load generated at the inlet of the actuator according to the manipulation of the joystick exceeds the target pressure, a control is performed to open any one of the first and second meter-out control valves by a maximum value that is determined by a difference between the set pressure at the hydraulic pump and the target pressure at the inlet of the actuator in a predetermined curve.

When the hydraulic actuator is driven in a stretchable manner, the first meter-in control valve and the first meter-out control valve are controlled to be opened and the second meter-in control valve and the second meter-out control valve are controlled to be closed in response to the control signal from the controller.

When the hydraulic actuator is driven in retractable stretchable manner, the second meter-in control valve and the second meter-out control valve are opened and the first meter-in control valve and the first meter-out control valve are closed in response to the control signal from the controller.

The first and second meter-in control valves and the first and second meter-out control valves are implemented as solenoid valves that are switched in response to the electric control signal from the controller.

### Advantageous Effect

The hydraulic actuator damping control system for a construction machine in accordance with an embodiment of the present invention as constructed above has the following advantages.

The manufacturing cost can be reduced through elimination of the necessity for additional installation of a separate damping control valve to reduce a shock occurring during an abrupt manipulation or a combined operation of a work apparatus, and shock and vibration according to the abrupt manipulation of the work apparatus can be reduced, thereby securing stability of the work and convenience of the operation.

### BRIEF DESCRIPTION OF THE INVENTION

The above objects, other features and advantages of the present invention will become more apparent by describing the preferred embodiments thereof with reference to the accompanying drawings, in which:

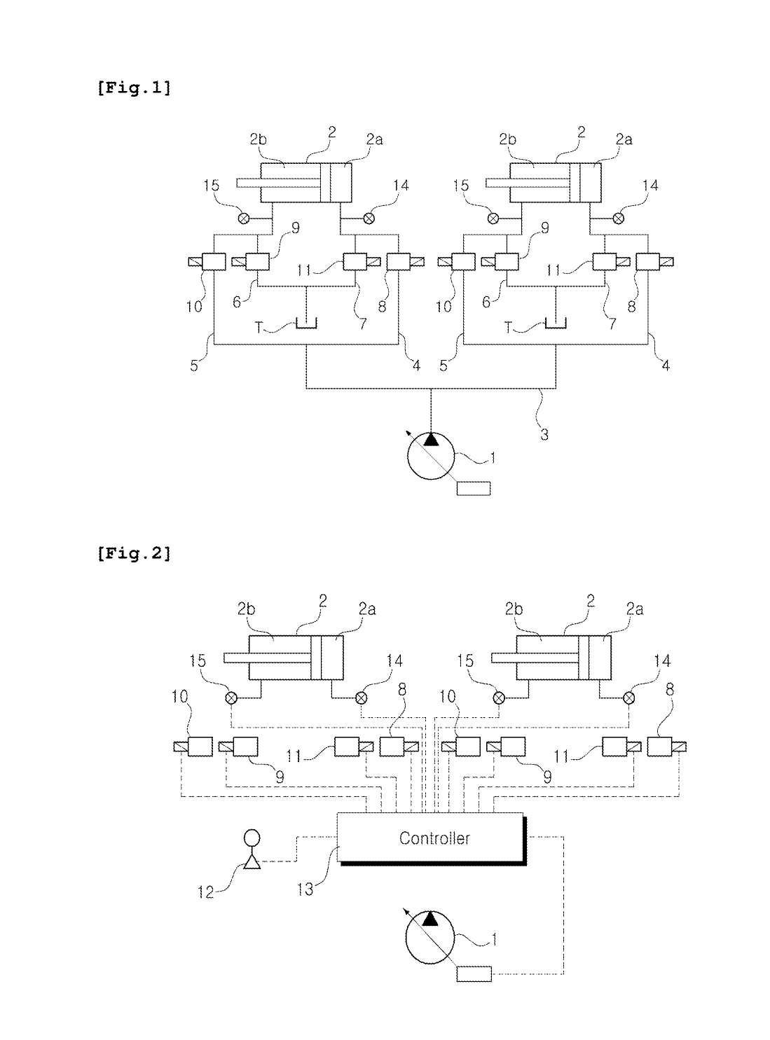

FIG. 1 is a hydraulic circuit diagram showing a hydraulic actuator damping control system for a construction machine in accordance with an embodiment of the present invention;

FIG. 2 is an electric configuration diagram showing a hydraulic actuator damping control system for a construction machine in accordance with an embodiment of the present invention;

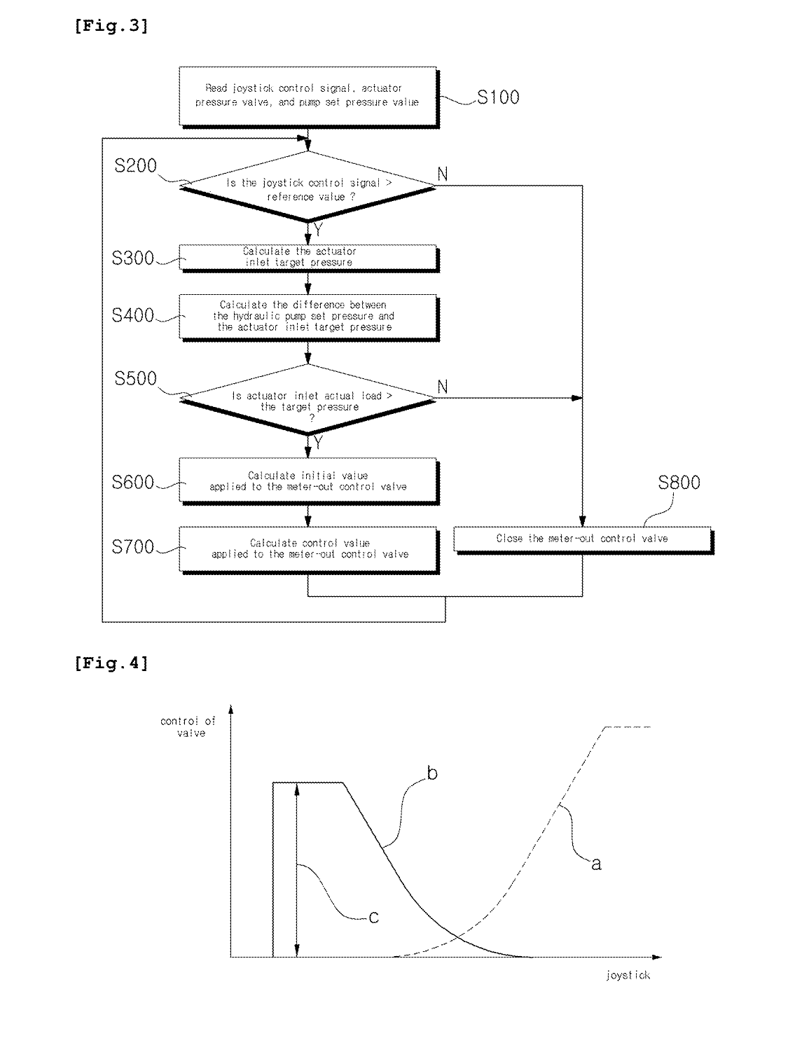

FIG. 3 is a flowchart showing a hydraulic actuator damping control method for a construction machine in accordance with an embodiment of the present invention; and

FIG. 4 is a graph showing a state in which a valve is controlled by a joystick in a hydraulic actuator damping control system for a construction machine in accordance with an embodiment of the present invention.

### EXPLANATION ON REFERENCE NUMERALS OF MAIN ELEMENTS IN THE DRAWINGS

1: variable displacement hydraulic pump

2: hydraulic actuator

3: discharge flow path

4: first supply path

5: second supply path

6: first discharge path

7: second discharge path

8: first meter-in control valve

9: first meter-out control valve

10: second meter-in control valve

11: second meter-out control valve

12: electric joystick

13: controller

14,15: pressure sensor

### Preferred Embodiments of the Invention

Now, preferred embodiments of the present invention will be described in detail with reference to the accompanying drawings. The matters defined in the description, such as the detailed construction and elements, are nothing but specific details provided to assist those of ordinary skill in the art in a comprehensive understanding of the invention, and the present invention is not limited to the embodiments disclosed hereinafter.

A hydraulic actuator damping control system for a construction machine in accordance with an embodiment of the present invention shown in FIGS. 1 to 4 includes:

at least one hydraulic actuator 2 (referring to for example “hydraulic cylinder”) that is connected to one or more variable displacement hydraulic pumps 1 (hereinafter, referred to as “hydraulic pumps”);

first and second supply paths 4 and 5 that are connected in parallel to a discharge flow path 3 of the hydraulic pump 1 and are configured to allow a hydraulic fluid from the hydraulic pump 1 to be respectively supplied to an inlet and an outlet of the hydraulic actuator 2 (hereinafter, referred to as “actuator”);

first and second discharge paths 6 and 7 that are branch-connected to the first and second supply paths 4 and 5, respectively, and are configured to allow the hydraulic fluid from the inlet and the outlet of the actuator to be returned to a hydraulic tank T;

a first meter-in control valve 8 and a first meter-out control valve 9 that are configured to be switched to control the flow rate of the hydraulic fluid that is supplied from the hydraulic pump 1 to the inlet (referring to “large chamber”) 2a of the actuator 2 and the flow rate of the hydraulic fluid that is returned from the outlet (referring to “small chamber”) 2b of the actuator 2 to the hydraulic tank T, respectively, so that the actuator can be driven in a direction (e.g., in a stretchable manner);

a second meter-in control valve 10 and a second meter-out control valve 11 that are configured to be switched to control the flow rate of the hydraulic fluid that is supplied from the hydraulic pump 1 to the outlet (referring to “small chamber”) 2b of the actuator 2 and the flow rate of the hydraulic fluid that is returned from the inlet (referring to “large chamber”) 2a of the actuator 2 to the hydraulic tank T, respectively, so that the actuator can be driven in the other direction (e.g., in a retractable manner);

an electric joystick 12 that is configured to output an electric control signal that corresponds to a manipulation amount by an operator; and

a controller 13 that is configured to control any one of the first and second meter-in control valves 8 and 10 to be opened by the control signal according to the manipulation amount of the electric joystick 12 and a control signal according to a load generated in the actuator 2 (as indicated by a curve “a” of a graph shown in FIG. 4), and output a control signal to open any one of the first and second meter-out control valves 9 and 11 that control the flow rate of the hydraulic fluids that are returned from the outlet 2b and the inlet 2a of the actuator 2 to the hydraulic tank T, respectively, if the load generated in the actuator 2 exceeds a reference value (e.g., if an abrupt manipulation or a combined operation of the work apparatus is performed by the joystick 12, thus leading to a great load change) (as indicated by a curve “b” of a graph shown in FIG. 4).

In this case, a pair of hydraulic actuators 2 connected in parallel to the hydraulic pump 1, the first and second meter-in control valves 8 and 10 that independently control the flow rate of the hydraulic fluid supplied from the hydraulic pump 1 to each actuator 2, and the first and second meter-out control valves 9 and 11 that independently control the flow rate of the hydraulic fluid returned from the actuator 2 to the hydraulic tank T, respectively, are arranged in a left and right symmetrical manner, and thus a detailed description on the configuration thereof will be omitted and the same elements are denoted by the same reference numerals.

In a hydraulic actuator damping control system for a construction machine, the system including a hydraulic actuator connected to a variable displacement hydraulic pump 1, a first meter-in control valve 8 and a first meter-out control valve 9 configured to be switched to control a hydraulic fluid that is supplied from a hydraulic pump 1 to an inlet (referring to “large chamber”) 2a of the actuator 2 and a hydraulic fluid that is returned from an outlet (referring to “small chamber”) 2b of the actuator 2 to a hydraulic tank T, respectively, so that the actuator can be driven in a direction (e.g., in a stretchable manner), a second meter-in control valve 10 and a second meter-out control valve 11 configured to be switched to control the flow rate of the hydraulic fluid that is supplied from the hydraulic pump 1 to the outlet (referring to “small chamber”) 2b of the actuator 2 and the flow rate of the hydraulic fluid that is returned from the inlet (referring to “large chamber”) 2a of the actuator 2 to the hydraulic tank T, respectively, so that the actuator can be driven in the other direction (e.g., in a retractable manner), an electric joystick 12, and a controller 13, the method for controlling the damping of the hydraulic actuator includes the steps of:

reading a control signal value through a manipulation of the joystick 12, a pressure value generated at the inlet of the actuator (referring to “hydraulic cylinder”) 2, and a set pressure value at the hydraulic pump 1 (S100);

determining a difference between the control signal value according to the manipulation of the joystick 12 and a reference value for determining whether the joystick 12 is manipulated (S200);

calculating a difference between the set pressure at the hydraulic pump 1 and a target pressure at the inlet of the actuator 2 if the control signal value according to the manipulation of the joystick 12 exceeds the reference value (S300,S400);

determining whether an actual load generated at the inlet of the actuator 2 exceeds the target pressure (S500); and

outputting a control signal to open any one of the first and second meter-out control valves 9 and 11 that controls the flow rate of the hydraulic fluid that is returned from the inlet of the actuator 2 to the hydraulic tank T, respectively, if the actual load generated at the inlet of the actuator 2 exceeds the target pressure (e.g., if an abrupt manipulation or a combined operation of the work apparatus is performed by the joystick 12, thus leading to a great load change) (S600,S700),

whereby if the actual load generated at the inlet of the actuator 2 according to the manipulation of the joystick 12 exceeds the target pressure, a closed loop is formed and a control is performed repeatedly to reduce a shock due to a load change that occurs in the actuator 2 by opening any one of the first and second meter-out control valves 9 and 11 according to the control signal applied to any one of the first and second meter-out control valves.

In this case, the hydraulic actuator damping control system further includes a pressure sensor 14 or 15 configured to detect the pressure generated from the inlet of the actuator 2 and transmit a detection signal to the controller 13.

If the actual load generated at the inlet of the actuator 2 according to the manipulation of the joystick 12 exceeds the target pressure, a control is performed to open any one of the first and second meter-out control valves 9 and 11 by a maximum value that is determined by a difference between the set pressure at the hydraulic pump 1 and the target pressure at the inlet of the actuator 2 in a predetermined curve.

When the hydraulic actuator 2 is driven in a stretchable manner, the first meter-in control valve 8 and the first meter-out control valve 9 are controlled to be opened and the second meter-in control valve 10 and the second meter-out control valve 11 are controlled to be opened in response to the control signal from the controller 13.

When the hydraulic actuator 2 is driven in retractable stretchable manner, the second meter-in control valve 10 and the second meter-out control valve 11 are controlled to be opened and the first meter-in control valve 8 and the first meter-out control valve 9 are controlled to be opened in response to the control signal from the controller 13.

The first and second meter-in control valves 8 and 10 and the first and second meter-out control valves 9 and 11 are implemented as solenoid valves that are switched in response to the electric control signal from the controller 13.

Hereinafter, a use example of the hydraulic actuator damping control system for a construction machine in accordance with an embodiment of the present invention will be described in detail with reference to the accompanying drawings.

First, a stretchable drive of the actuator 2 will be described hereinafter.

The first meter-in control valve 8 and the first meter-out control valve 9 are switched to be opened and the second meter-in control valve 10 and the second meter-out control valve 11 are switched to be closed in response to a control signal from the controller 13, so that the hydraulic fluid discharged from the hydraulic pump 1 is supplied to the large chamber 2a of the actuator 2 via the discharge flow path 3, the first supply path 4, and the first meter-in control valve 8 in this order. Simultaneously, the hydraulic fluid from the small chamber 2b of the actuator 2 is returned to the hydraulic tank T via the first meter-out control valve 9 and the second discharge path 7. Thus, the hydraulic actuator 2 is driven in a stretchable manner.

Like this, in the case where the abrupt manipulation or the combined operation of the work apparatus is performed by the joystick to drive the actuator 2 in the stretchable manner to cause a load change to occur, the second meter-out control valve 11 is switched to be opened in response to the control signal from the controller 13. For this reason, a part of the hydraulic fluid supplied from the hydraulic pump 1 to the inlet (i.e., large chamber 2a) of the actuator 2 is returned to the hydraulic tank T to perform a damping function so that a pressure change occurring in the actuator 2 can be reduced, thereby leading to a reduction of shock and vibration of the actuator 2.

On the other hand, a retractable drive of the actuator 2 will be described hereinafter.

The second meter-in control valve 10 and the second meter-out control valve 11 are switched to be opened and the first meter-in control valve 8 and the first meter-out control valve 9 are switched to be closed in response to the control signal from the controller 13, so that the hydraulic fluid discharged from the hydraulic pump 1 is supplied to the small chamber 2b of the actuator 2 via the discharge flow path 3, the second supply path 5, and the second meter-in control valve 10 in this order. Simultaneously, the hydraulic fluid from the large chamber 2a of the actuator 2 is returned to the hydraulic tank T via the second meter-out control valve 11 and the first discharge path 6. Thus, the hydraulic actuator 2 is driven in a retractable manner.

Like this, in the case where the abrupt manipulation or the combined operation of the work apparatus is performed by the joystick to drive the actuator 2 in the retractable manner to cause a load change to occur, the first meter-out control valve 9 is switched to be opened in response to the control signal from the controller 13. For this reason, a part of the hydraulic fluid supplied from the hydraulic pump 1 to the outlet (i.e., small chamber 2b) of the actuator 2 is returned to the hydraulic tank T to perform a damping function so that a pressure change occurring in the actuator 2 can be reduced, thereby leading to a reduction of shock and vibration of the actuator 2.

As described above, the first meter-in control valve 8 and the first meter-out control valve 9 can be switched to be opened to cause the actuator 2 to be driven in the stretchable manner, and the second meter-in control valve 10 and the second meter-out control valve 11 can be switched to be opened to cause the actuator 2 to be driven in the retractable manner. In other words, the actuators 2 is controlled to be driven in the retractable manner by the first meter-in control valve 8, the first meter-out control valve 9, the second meter-in control valve 10, and the second meter-out control valve 11 that are controlled to be connected to each other in a bridge pattern and to be driven independently.

Hereinafter, an operation in which a shock and a vibration occurring in the actuator due to a pressure change are reduced by the hydraulic actuator damping control system for a construction machine in accordance with an embodiment of the present invention will be described hereinafter with reference to FIG. 3.

At step S100, the controller 13 reads a control signal value through a manipulation of the joystick 12, a pressure value generated at the inlet of the actuator (referring to “hydraulic cylinder”) 2, and a set pressure value at the hydraulic pump 1, respectively.

At step S200, the controller 13 determines a difference between the control signal value according to the manipulation of the joystick 12 and a reference value for determining whether the joystick 12 is manipulated. If it is determined at step S200 that the control signal value according to the manipulation of the joystick 12 exceeds the reference value, the program proceeds to step S300. On the contrary, if it is determined at step S200 that the control signal value according to the manipulation of the joystick 12 is less than the reference value, the program proceeds to step S800.

At step S300, the controller 13 calculates a target pressure of the hydraulic fluid supplied to the inlet of the actuator 2 according to the manipulation of the joystick 12.

At step S400, the controller 13 calculates a difference between the set pressure at the hydraulic pump 1 and a target pressure at the inlet of the actuator 2.

At step S500, the controller 13 determines whether an actual load generated at the inlet of the actuator 2 exceeds the target pressure. If it is determined at step S500 that the actual load generated at the inlet of the actuator 2 exceeds the target pressure, the program proceeds to step S600. On the contrary, if it is determined at step S500 that the actual load generated at the inlet of the actuator 2 is less than the target pressure, the program proceeds to step S800

At step S600, the controller 13 calculates a maximum value that is determined by a difference between the set pressure at the hydraulic pump 1 and the target pressure at the inlet of the actuator 2 in a predetermined curve (as indicated by a curve “c” of a graph shown in FIG. 4).

At subsequent step S700, the controller 13 outputs a control signal to open any one of the first and second meter-out control valves 9 and 11 to control the flow rate of the hydraulic fluid that is returned from the inlet of the actuator 2 to the hydraulic tank T, respectively, if it is determined at step S500 that the actual load generated at the inlet of the actuator 2 exceeds the target pressure (as indicated by a curve “b” of a graph shown in FIG. 4), and then the program returns to step S200 where the controller 13 repeatedly performs steps S200 to S600.

In this case, the control signal valve that is applied to any one of the first and second meter-out control valves 9 and 11 from the controller 13 to switch any one of the first and second meter-out control valves 9 and 11 is determined by the following equation:

Control signal value=(K)×(meter-out control valve maximum value)×(damp curve).

wherein K is a parameter for tuning, meter-out control valve maximum value is a maximum value that is determined by a difference between the set pressure at the hydraulic pump 1 and the target pressure at the inlet of the actuator 2 in a predetermined curve, and damp curve means a value determined by the a predetermined curve according to the manipulation signal of the joystick 12.

At step S800, the controller 13 controls any one of the first and second meter-out control valves 9 and 11 to be switched to be closed if it is determined at step S200 that the control signal value according to the manipulation of the joystick 12 is less than the reference value for determining whether the joystick 12 is manipulated and if it is determined at step S500 that the actual load generated at the inlet of the actuator 2 is less than the target pressure, and then the program returns to step S200 where the controller 13 repeatedly performs steps S200 to S500.

As described above, in the case where the actual load generated at the inlet of the actuator 2 exceeds the target pressure when an abrupt manipulation or a combined operation of the work apparatus is performed by the joystick 12, any one of the first and second meter-out control valves 9 and 11 is switched to be opened in response to the control signal from the controller 13 so that a part of the hydraulic fluid supplied to the inlet of the actuator can be returned to the hydraulic tank T to reduce a shock due to a load change occurring in the actuator 2.

While the present invention has been described in connection with the specific embodiments illustrated in the drawings, they are merely illustrative, and the invention is not limited to these embodiments. It is to be understood that various equivalent modifications and variations of the embodiments can be made by a person having an ordinary skill in the art without departing from the spirit and scope of the present invention. Therefore, the true technical scope of the present invention should not be defined by the above-mentioned embodiments but should be defined by the appended claims and equivalents thereof.

### INDUSTRIAL APPLICABILITY

As described above, hydraulic actuator damping control system for a construction machine in accordance with an embodiment of the present invention, the necessity for additional installation of a separate damping control valve for reducing a shock or a vibration occurring in a hydraulic actuator due to a load change during an abrupt manipulation or a combined operation of a work apparatus such as a boom or the like by an electric joystick is eliminated, and the shock according to the abrupt manipulation of the work apparatus can be reduced, thereby securing stability of the work and convenience of the operation.

1. A hydraulic actuator damping control system for a construction machine, the system comprising:
at least one hydraulic actuator connected to a variable displacement hydraulic pump;
first and second supply paths connected in parallel to a discharge flow path of the hydraulic pump 1 and configured to allow a hydraulic fluid from the hydraulic pump 1 to be respectively supplied to an inlet and an outlet of the actuator;
first and second discharge paths branch-connected to the first and second supply paths, respectively and configured to allow the hydraulic fluid from the actuator to be returned to a hydraulic tank T;
a first meter-in control valve and a first meter-out control valve configured to be switched to control the flow rate of the hydraulic fluid that is supplied from the hydraulic pump to the inlet of the actuator and the flow rate of the hydraulic fluid that is returned from the outlet of the actuator to the hydraulic tank T, respectively, so that the actuator can be driven in a direction;
a second meter-in control valve and a second meter-out control valve configured to be switched to control the flow rate of the hydraulic fluid that is supplied from the hydraulic pump to the outlet of the actuator and the flow rate of the hydraulic fluid that is returned from the inlet of the actuator to the hydraulic tank T, respectively, so that the actuator can be driven in the other direction;
an electric joystick configured to output an electric control signal that corresponds to a manipulation amount; and
a controller configured to control any one of the first and second meter-in control valves to be opened by the control signal according to the manipulation amount of the electric joystick and a control signal according to a load generated in the actuator, and output a control signal to open any one of the first and second meter-out control valves that control the flow rate of the hydraulic fluids that are returned from the outlet and the inlet of the actuator to the hydraulic tank T, respectively, if the load generated in the actuator exceeds a reference value.

2. A method for controlling the damping of a hydraulic actuator in a hydraulic actuator damping control system for a construction machine, the system comprising a hydraulic actuator connected to a variable displacement hydraulic pump, a first meter-in control valve and a first meter-out control valve configured to be switched to control a hydraulic fluid that is supplied from a hydraulic pump to an inlet of the actuator and a hydraulic fluid that is returned from an outlet of the actuator to a hydraulic tank T, respectively, so that the actuator can be driven in a direction, a second meter-in control valve and a second meter-out control valve configured to be switched to control the flow rate of the hydraulic fluid that is supplied from the hydraulic pump to the outlet of the actuator and the flow rate of the hydraulic fluid that is returned from the inlet of the actuator to the hydraulic tank T, respectively, so that the actuator can be driven in the other direction, an electric joystick, and a controller, the method comprising the steps of:
reading a control signal value through a manipulation of the joystick, a pressure value generated at the inlet of the actuator, and a set pressure value at the hydraulic pump;
determining a difference between the control signal value according to the manipulation of the joystick and a reference value for determining whether the joystick is manipulated;
calculating a difference between the set pressure at the hydraulic pump and a target pressure at the inlet of the actuator if the control signal value according to the manipulation of the joystick exceeds the reference value;
determining whether an actual load generated at the inlet of the actuator exceeds the target pressure; and
outputting a control signal to open any one of the first and second meter-out control valves that controls the flow rate of the hydraulic fluid that is returned from the inlet of the actuator to the hydraulic tank T, respectively, if the actual load generated at the inlet of the actuator exceeds the target pressure;
whereby if the actual load generated at the inlet of the actuator according to the manipulation of the joystick exceeds the target pressure, a closed loop is formed and a control is repeatedly performed to reduce a shock due to a load change that occurs in the actuator by opening any one of the first and second meter-out control valves according to the control signal applied to any one of the first and second meter-out control valves.

3. The method according to claim 2, wherein the hydraulic actuator damping control system further comprises a pressure sensor configured to detect the pressure generated in the actuator and transmits a detection signal to the controller.

4. The method according to claim 2, wherein if the actual load generated at the inlet of the actuator according to the manipulation of the joystick exceeds the target pressure, a control is performed to open any one of the first and second meter-out control valves by a maximum value that is determined by a difference between the set pressure at the hydraulic pump and the target pressure at the inlet of the actuator in a predetermined curve.

5. The hydraulic actuator damping control system for a construction machine according to claim 1, wherein when the hydraulic actuator is driven in a stretchable manner, the first meter-in control valve and the first meter-out control valve are controlled to be opened and the second meter-in control valve and the second meter-out control valve are controlled to be opened in response to the control signal from the controller.

6. The hydraulic actuator damping control system for a construction machine according to claim 1, wherein when the hydraulic actuator is driven in retractable stretchable manner, the second meter-in control valve and the second meter-out control valve are controlled to be opened and the first meter-in control valve and the first meter-out control valve are controlled to be opened in response to the control signal from the controller.

7. The hydraulic actuator damping control system for a construction machine according to claim 1, wherein the first and second meter-in control valves and the first and second meter-out control valves are implemented as solenoid valves that are switched in response to the electric control signal from the controller.
